(19) United States
(12) Patent Application Publication
(10) Pub. No.: US 2011/0158341 A1
(43) Pub. Date: Jun. 30, 2011

(54) METHOD AND APPARATUS FOR PHASE QUANTIZATION AND EQUAL GAIN PRECODING USING LATTICES

(75) Inventors: Shang-Ho Tsai, Hsinchu City (TW); Hsiao-Lan Chiang, Miaoli City (TW); Ping-Heng Kuo, Pingtung City (TW); Pang-An Ting, Fongyuan City (TW); Gene C.H. Chuang, Hsinchu City (TW)

(73) Assignee: Industrial Technology Research Institute.

(21) Appl. No.: 12/898,413

(22) Filed: Oct. 5, 2010

Related U.S. Application Data
(60) Provisional application No. 61/290,881, filed on Dec. 29, 2009.
(60) Provisional application No. 61/294,286, filed on Jan. 12, 2010.

(51) Int. Cl. H04B 7/02

(52) U.S. Cl. 375/267

(57) ABSTRACT

A method and apparatus are disclosed for phase quantization and equal gain precoding in a wireless communication system. The method includes scaling, by a receiving device, a phase vector based on a predetermined scaling factor to determine a first lattice point. The method also includes determining, by the receiving device, a second lattice point based on the determined first lattice point. In addition, the method includes determining, by the receiving device, a quantized phase vector based on the determined second lattice point and the predetermined scaling factor.

### PRIORITY

This application claims the benefit of priority of U.S. Provisional Application No. 61/290,881, filed Dec. 29, 2009, and the benefit of priority of U.S. Provisional Application No. 61/294,286, filed Jan. 12, 2010, both of which are incorporated by reference herein in their entirety for any purpose.

### TECHNICAL FIELD

The present disclosure relates generally to a method and apparatus for communication and, more particularly, to a method and apparatus for phase quantization and equal gain precoding using lattices.

### BACKGROUND

Wireless communication systems allow wireless devices to communicate without the necessity of wired connections. Because wireless systems have become so integrated into daily life, there is a growing demand for wireless communication systems that support multimedia services such as speech, audio, video, file and web downloading, and the like. Various wireless communication protocols and transmission control mechanisms have been developed to meet the growing demands of multimedia services over wireless communication networks and to improve the performance of these multimedia services.

In wireless communication systems, multiple-input and multiple-output (MIMO), a form of smart antenna technology, involves the use of multiple antennas at both the transmitter and receiver to improve communication performance. Originally, MIMO technology schemes were defined as point-to-point communication systems having multiple antenna elements at both the transmitter and receiver. More recently, however, MIMO technology schemes have been extended to apply to more complicated scenarios such as space division multiple access (SDMA) and cooperative communications. This extension is possible because the cooperative processing available among multiple terminals, each terminal having a single antenna, can be deemed as a single transmitting or receiving node with a virtual antenna array.

Precoding is a scheme used to support MIMO technology schemes. In precoding, multiple streams of signals are emitted from the transmit antennas with independent and appropriate weighting per each antenna such that the link throughput is maximized at the receiving device. If complete channel formation is known to the transmitter, precoders and decoders can be designed by optimizing several parameters such as minimum mean square error (MMSE), maximizing information rate, or maximizing SNR.

While codebook-based precoding may achieve optimal performance for a given bit resolution, it may require exhaustive search to find the most suitable codeword. Moreover, many operational procedures may be too complex to implement in practical systems, require significant amounts of memory, and/or the latency caused by operational procedures may lead to degradation of resultant performance.

The disclosed embodiments are directed to overcoming one or more of the problems set forth above.

### SUMMARY

In one exemplary embodiment, the present disclosure is directed to a method for phase quantization and equal gain precoding in a wireless communication system, comprising: scaling, by a receiving device, a phase vector based on a predetermined scaling factor to determine a first lattice point; determining, by the receiving device, a second lattice point based on the determined first lattice point; and determining, by the receiving device, a quantized phase vector based on the determined second lattice point and the predetermined scaling factor.

In another exemplary embodiment, the present disclosure is directed to an apparatus for phase quantization and equal gain precoding in a wireless communication system, the apparatus comprising: at least one memory to store data and instructions; and at least one processor configured to access the at least one memory and, when executing the instructions, to: scale a phase vector based on a predetermined scaling factor to determine a first lattice point; determine a second lattice point based on the determined first lattice point; and determine a quantized phase vector based on the determined second lattice point and the predetermined scaling factor.

In one exemplary embodiment, the present disclosure is directed to a method for phase quantization and equal gain precoding in a wireless communication system, comprising: scaling, by a receiving device, a phase vector based on a predetermined scaling factor to determine a first lattice point; determining, by the receiving device, a second lattice point based on the determined first lattice point; determining, by the receiving device, a quantized phase vector based on the determined second lattice point and the predetermined scaling factor; calculating, by the receiving device, a scalar value for the first lattice point; converting, by the receiving device, the quantized phase vector to a bitstream based on the calculated scalar value; and transmitting, by the receiving device, the bitstream to a transmitting device.

In another exemplary embodiment, the present disclosure is directed to an apparatus phase quantization and equal gain precoding in a wireless communication system, the apparatus comprising: at least one memory to store data and instructions; and at least one processor configured to access the at least one memory and, when executing the instructions, to: scale a phase vector based on a predetermined scaling factor to determine a first lattice point; determine a second lattice point based on the determined first lattice point; determine a quantized phase vector based on the determined second lattice point and the predetermined scaling factor; calculate a scalar value for the first lattice point; convert the quantized phase vector to a bitstream based on the calculated scalar value; and transmit the bitstream to a transmitting device.

### BRIEF DESCRIPTION OF THE DRAWINGS

FIG. 1 is a diagram illustrating multiple-input multiple-output (MIMO) communication in an exemplary wireless communication system, consistent with certain disclosed embodiments;

FIG. 2a is a diagram of an exemplary base station (BS), consistent with certain disclosed embodiments;

FIG. 2b is a diagram of an exemplary receiving device (RD), consistent with certain disclosed embodiments;

FIG. 3 is a diagram illustrating an exemplary MIMO transmission and reception, consistent with certain disclosed embodiments;

FIG. 4 is a flowchart illustrating a user and precoder selection algorithm, consistent with certain disclosed embodiments;

FIG. 5 is a flowchart illustrating a bit conversion algorithm, consistent with certain disclosed embodiments;

FIG. 6a is a diagram illustrating two-dimensional phase quantization in an exemplary wireless communication system, consistent with certain disclosed embodiments;

FIG. 6b is a diagram illustrating two-dimensional phase quantization in an exemplary wireless communication system, consistent with certain disclosed embodiments;

FIG. 7 is a diagram illustrating phase quantization in an exemplary wireless communication system, consistent with certain disclosed embodiments;

FIG. 8 is a diagram illustrating phase quantization in an exemplary wireless communication system, consistent with certain disclosed embodiments;

FIG. 9 is a diagram illustrating phase quantization in an exemplary wireless communication system, consistent with certain disclosed embodiments;

FIG. 10 is a diagram illustrating phase quantization in an exemplary wireless communication system, consistent with certain disclosed embodiments; and

FIG. 11 is a flowchart illustrating a user and precoder selection algorithm, consistent with certain disclosed embodiments.

### DETAILED DESCRIPTION

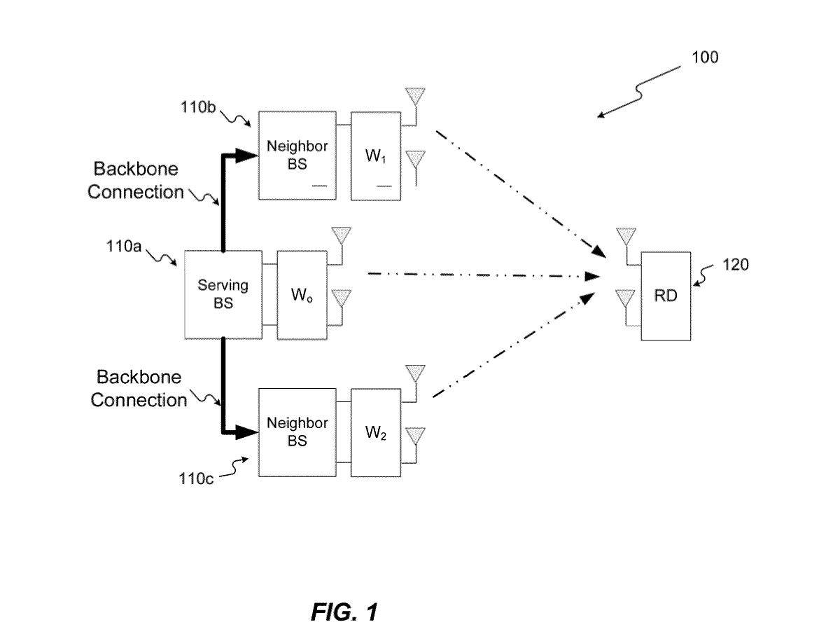

FIG. 1 is a diagram of an exemplary multiple-input multiple-output (MIMO) wireless communication system 100. In one exemplary embodiment, wireless communication system 100 of FIG. 1 may be based, for example, on the Worldwide Interoperability for Microwave Access (WiMAX), which is promulgated by the WiMax Forum, and is based on the IEEE 802.16 family of standards and technologies. In other embodiments, wireless communication system 100 of FIG. 1 may be based, for example, on the 3^{rd} Generation Partnership Project (3GPP) family of standards and technologies.

In some embodiments, wireless communication system 100 may be a multi-transmitter collaborative communication system having a single transmission device with multiple antenna elements. In other embodiments, wireless communication system 100 may be a multi-transmitter collaborative communication system having a set of transmission devices working in cooperation with each other. In the embodiment of FIG. 1, wireless communication system 100 is a multi-user (MU) MIMO wireless communication system 100 in which downlink signals are sent from multiple transmission devices to one or more receiving devices. The embodiment of FIG. 1 may be referred to as a collaborative multiple-input multiple-output (CO-MIMO) wireless communication system.

As shown in FIG. 1, wireless communication system 100 may include one or more transmission devices, referred to herein as base stations (BS) 110, e.g., BS 110a, BS 110b, and BS 110c, and one or more receiving devices (RDs) 120. BS 110 may be any type of communication device configured to transmit and/or receive data and/or communications to and/or from one or more RDs 120 in wireless communication system 100, many of which are known in the art. In some embodiments, BS 110 may also be referred to as, for example, a Node-B, a base transceiver system (BTS), an access point, etc. In other embodiments, BS 110 may be a relay station, an intermediate node, an intermediary, or any type of mobile station. In one exemplary embodiment, BS 110 may have a broadcast/reception range within which BS 110 may wirelessly communicate with one or more RDs 120. Broadcast ranges may vary due to power levels, location, and interference (physical, electrical, etc.).

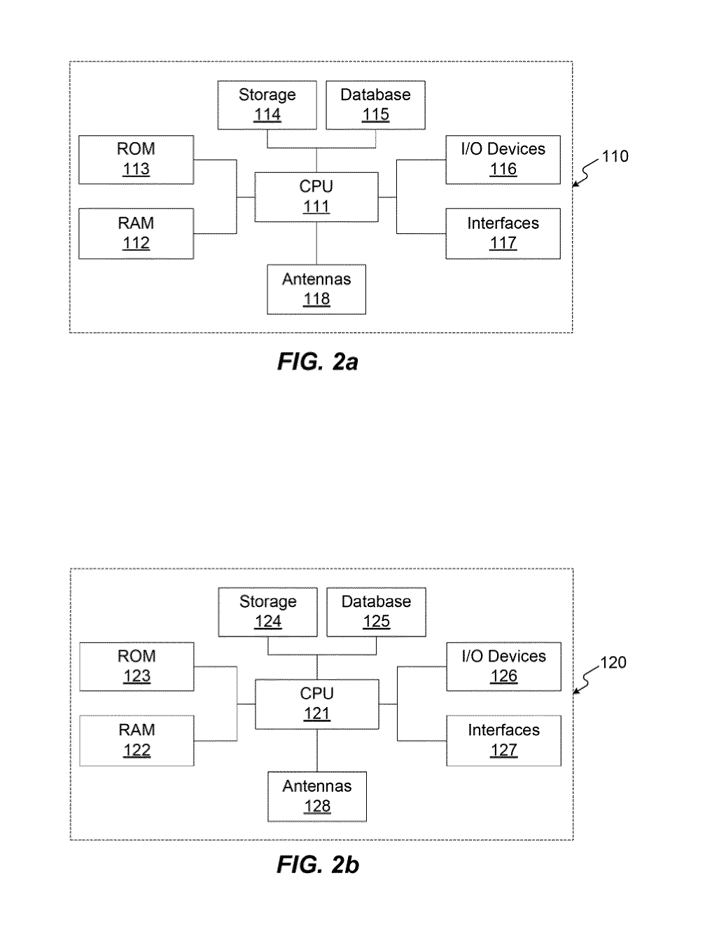

FIG. 2a is a diagram of an exemplary BS 110, consistent with certain disclosed embodiments. As shown in FIG. 2a, each BS 110 may include one or more of the following components: at least one central processing unit (CPU) 111 (also referred to herein as a processor) configured to execute computer program instructions to perform various processes and methods, random access memory (RAM) 112 and read only memory (ROM) 113 configured to access and store information and computer program instructions, memory 114 to store data and information, databases 115 to store tables, lists, or other data structures, I/O devices 116, interfaces 117, antennas 118, etc. Each of these components is well-known in the art and will not be discussed further.

RD 120 may be any type of computing device configured to wirelessly transmit and/or receive data to and from BS 110 in wireless communication system 100. RD 120 may include, for example, servers, clients, desktop computers, laptop computers, network computers, workstations, personal digital assistants (PDA), tablet PCs, scanners, telephony devices, pagers, cameras, musical devices, etc. In addition, RD 120 may include one or more wireless sensors in a wireless sensor network configured to communicate by means of centralized and/or distributed communication. In one exemplary embodiment, RD 120 may be a mobile computing device. In another exemplary embodiment, RD 120 may be a fixed computing device operating in a mobile environment, such as, for example, a bus, a train, an airplane, a boat, a car, etc.

FIG. 2b is a diagram of an exemplary RD 120, consistent with certain disclosed embodiments. As shown in FIG. 2b, each RD 120 may include one or more of the following components: at least one central processing unit (CPU) 121 (also referred to herein as a processor) configured to execute computer program instructions to perform various processes and methods, random access memory (RAM) 122 and read only memory (ROM) 123 configured to access and store information and computer program instructions, memory 124 to store data and information, databases 125 to store tables, lists, or other data structures, I/O devices 126, interfaces 127, antennas 128, etc. Each of these components is well-known in the art and will not be discussed further.

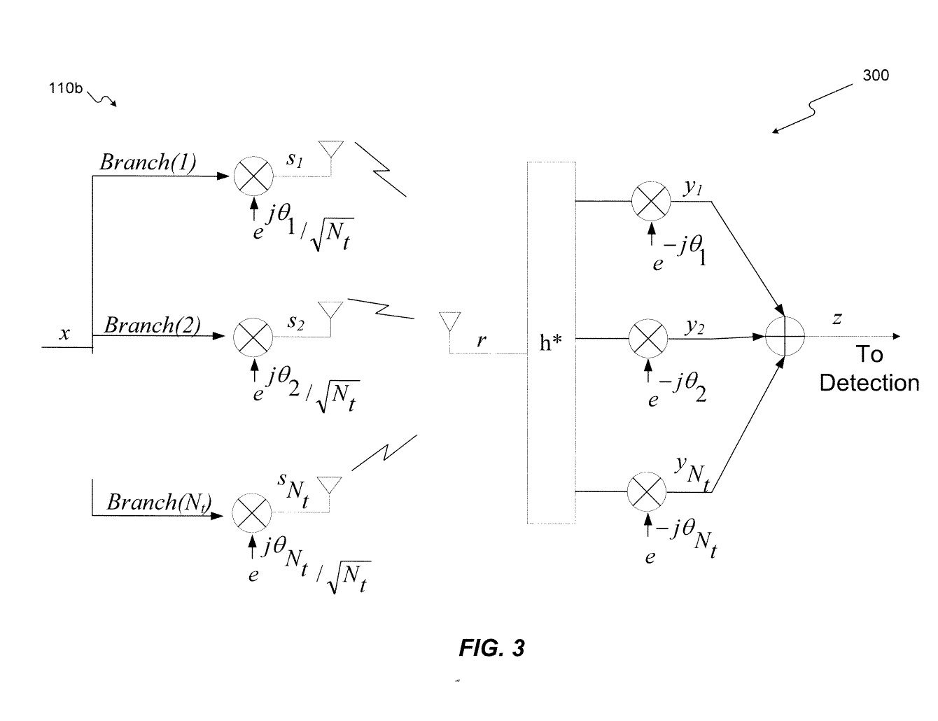

FIG. 3 is a diagram of an exemplary equal gain precoder 300, consistent with certain disclosed embodiments. In some embodiments, equal gain precoder 300 may be used to independently weight multiple streams of transmission signals emitted from each of a plurality of transmission antennas so that link throughput is maximized at a receiver output. In the embodiment of FIG. 3, when complete channel information is known to the transmitter, e.g., BS 110, the precoders and decoders may be jointly designed by optimizing several parameters, such as, for example, minimum mean square error (MMSE), maximum information rate, or maximum signal to noise ratio (MSNR). One or more components of equal gain precoder 300 may be included in one or more BSs 110 and/or RDs 120.

On the transmitter side (e.g., one or more BSs 110), equal gain precoder 300 may include Nₜ transmit antennas that may be included in one or more BSs 110. As shown in FIG. 3, one transmit symbol may be sent for precoding to each of Nₜ branches (e.g., Branch(1), Branch(2), . . . , Branch(Nₜ)), where each branch corresponds to one transmit antenna. In some embodiments, a transmit symbol may be the number of carriers equal to the size of a Fourier transform, and may be constructed from data carriers, pilot carriers, null carriers, etc. In certain embodiments, the transmit symbols may be modulated according to a digital modulation scheme, such as, for example, quadrature phase-key shifting (QPKS), quadrature amplitude modulation (e.g., 16-QAM, 64-QAM, 128-QAM, 256-QAM, etc.), etc.

The transmit symbol in each of the Nₜ branches may be multiplied by a different phase rotation, according to Equation 1, as follows:

e^{jθ}^{₁}/\sqrt{Nₜ}, . . . e^{jθ}^{ₜ}/\sqrt{Nₜ}, Equation 1
wherein
   e^{jθ}^{₁} is the phasor;
   θ is the phase;
   Nₜ is the number of antennas; and
   t is the index of the transmit antenna.

To maintain the same total transmit power for each symbol, the phasor may be divided by \sqrt{Nₜ}, as shown in Equation 1. The phase θ may be received from the receiver, e.g., RD 120, via a feedback message based on an estimated channel condition. After precoding, a symbol vector s=(s₁, s₂, s₃,) to be transmitted from one or more BSs 110 to one or more RDs 120 may be determined according to Equation 2, as follows:

$$s = \frac{1}{\sqrt{{N}_{t}}} px , \qquad Equation 2$$

wherein
   p is an Nₜ×1 vector defined as p=(e^{jθ}^{₁}e^{jθ}^{₂} . . . e^{jθ}^{_{Nt}})^{t};
   Nₜ is the number of antennas;
   x is the transmitted symbol;
   and
   t is the index of the transmit antenna.

At the receiver side (e.g., one or more RDs 120), a received symbol r may be determined according to Equation 3, as follows:

r=h¹s+n, Equation 3
wherein
   h is an Nₜ×1 channel vector consisting of channel coefficients given by h=(h₁ h₂ . . . h_{N}_{ₜ})^{t};
   Nₜ is the number of antennas;
   s is the transmitted symbol vector;
   n is a noise scalar; and
   t is the index of the transmit antenna.

In the embodiment of FIG. 3, the received symbol r may first be multiplied by the conjugate of the channel vector, i.e., h*. Then, the received symbol r may be multiplied by the inverse phase rotation (e.g., e^{-jθ}^{₁}, e^{-jθ}^{₂}, . . . , e^{-jθ}^{_{Nt}}) to form a scalar z. The mathematical expression for these operations is given by Equation 4, as follows:

z=p^{†}h*r,
wherein
   p^{†} is a conjugate transpose of a vector p;
   h* is the conjugate of the channel vector; and
   r is the received symbol.

Using Equations 1, 3, and 4, above, the relationship between x and z may be given by Equation 5, as follows:

$$z = \frac{1}{\sqrt{{N}_{t}}} \underbrace{{p}^{†} {h}^{*} {h}^{†} px}_{γ} + {p}^{†} {h}^{*} r , \qquad Equation 5$$

wherein
   p^{†}h*r is the noise after decoding;
   γ is a gain effect including diversity gain and precoding gain;
   p is an Nt×1 vector defined as p=(e^{jθ}^{₁}e^{jθ}^{₂} . . . e^{jθ}^{_{Nt}})^{t};
   Nₜ is the number of antennas; and
   h is an Nt×1 channel vector consisting of channel coefficients given by h=(h₁ h₂ . . . h_{N}_{ₜ})^{t}.

Generally, lattice points (i.e., codeword vectors) may be generated according to Equation 6, as follows:

wᵢ=Tuᵢ, Equation 6
wherein
   T is an m×n generation matrix of a lattice, where m≧n; and
   uᵢ is 0, ±1, ±2, . . . .

Lattice quantization may be used to find the lattice point closest to a given vector w, according to Equation 7, as follows:

$$\hat{w} = arg {min}_{{w}_{i}} {‖ {w}_{i} - w ‖}^{2} , \qquad Equation 7$$

wherein
   ŵ is the most suitable lattice point given vector w; and
   wᵢ are the lattice points.

Because of the regular structures of lattices, there may be no need to perform an exhaustive search to find the most suitable lattice point. Instead, the algorithm of Equation 7, also referred to herein as the fast algorithm, may be used to identify the most suitable lattice point ŵ. In such embodiments, the computational efforts required to determine the most suitable lattice point ŵ may be reduced, thereby reducing computational costs and decoding latency. In addition, because there is no need to use extra memory to store a codebook, lattice quantization may lead to improved use of memory for systems with large numbers of codewords because the lattice codewords may be generated in real-time.

For example, using Equations 6 and 7 above, the most suitable lattice point ŵ may be found, and the corresponding ûᵢ may be calculated according to Equation 8, as follows:

ûᵢ=T^{inv}ŵ, Equation 8
wherein
   T^{inv} is the pseudo inverse of T; and
   ûᵢ is 0, ±1, ±2, . . . .

In this embodiment, ûᵢ may be sent to a transmitter, e.g., BS 110, from a receiver, e.g., RD 120, via one or more feedback messages. The transmitter, e.g., BS 110, may, in turn, obtain a corresponding codeword by applying Equation 6 above.

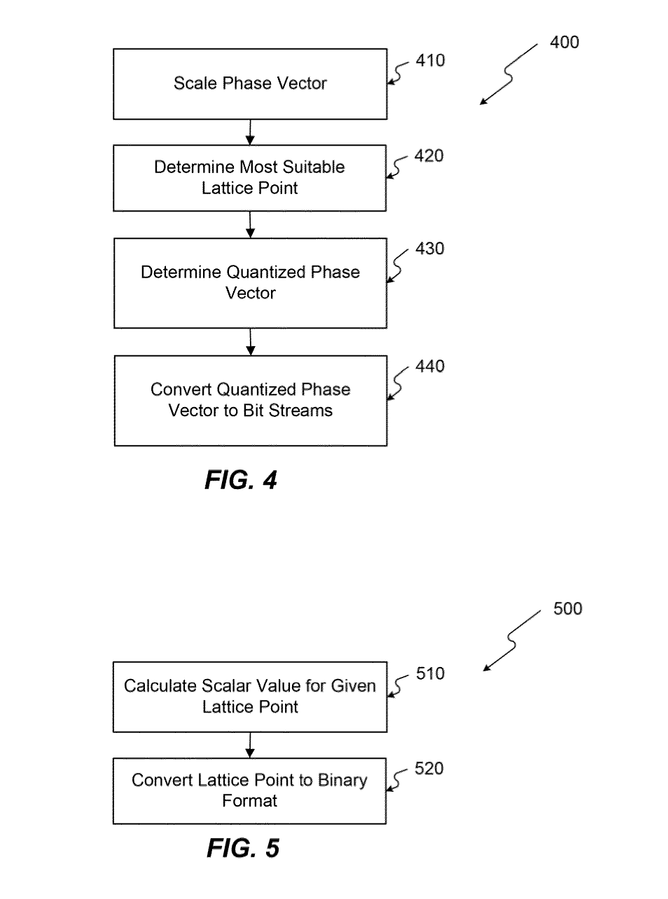

FIG. 4 is an exemplary flowchart 400 illustrating phase quantization in a wireless communication system, such as wireless communication system 100, consistent with certain disclosed embodiments. Specifically, FIG. 4 illustrates an embodiment in which equal gain precoder 300 performs lattice scaling and phase quantization. In the disclosed embodiments, scaling may be used to achieve different quantization bits. For a phase quantizer, the phase to be quantized is in the range of [−π, π].

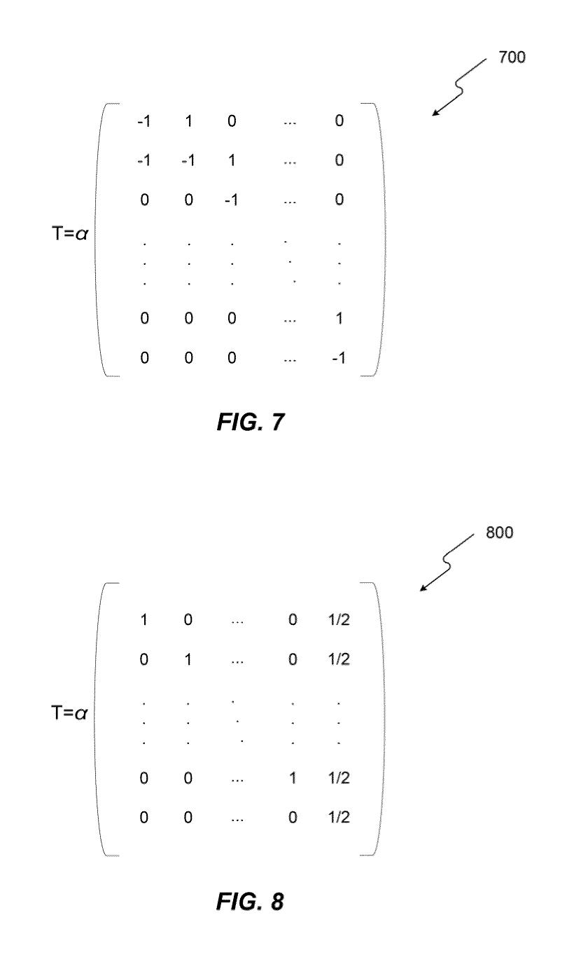

As shown in FIG. 4, a phase vector Θ, where Θ=(θ₁ θ₂ . . . θₙ), may be scaled (410). In some embodiments, a predetermined scaling factor α may be used such that phase vector Θ is scaled by scaling factor α, i.e., w=Θ/α, so that the maximum value of |θᵢ/α| is less than c, where c is either a positive integer or a positive integer plus ½, to produce a lattice point w. Determination of scaling factor α may be based on one or more rules, as discussed in more detail below in connection with FIGS. 7, 8, and 9.

The most suitable lattice point ŵ may be determined using lattice point w (420). In some embodiments, the fast algorithm of Equation 7 above may be used to obtain the most suitable lattice point ŵ, i.e.,

$$\hat{w} = arg {min}_{{w}_{i}} {‖ {w}_{i} - w ‖}^{2} ,$$

from which the quantized phase vector may be determined (430). In certain embodiments, the quantized phase vector may be obtained by de-scaling, i.e., \hat{Θ}=αŵ. Next, the quantized phase vectors may be converted to bit streams (440). The bit streams may be stored by RD 120 and/or transmitted to BS 110 by RS 120 via one or more feedback messages.

FIG. 5 is an exemplary flowchart 500 illustrating the conversion of quantized phase vectors to bit streams in a wireless communication system, such as wireless communication system 100, consistent with certain disclosed embodiments. Specifically, rather than constructing look-up tables for lattice point w, FIG. 5 illustrates an embodiment in which quantized phase vectors are converted to bit streams for digital feedback, as discussed in connection with item 440 of FIG. 4.

Given a lattice point w=[w₁, w₂, . . . , wₙ], its corresponding scalar value S may be calculated (510). In some embodiments, the corresponding scalar value S may be calculated according to Equation 9, as follows:

$$S = fix [ \frac{( {w}_{1} + c ) mod ( 2 c )}{2} ] + {\sum }_{i = 2}^{n} \{ \frac{{( 2 c )}^{i - 1}}{2} [ ( {w}_{i} + c ) mod ( 2 c ) ] \} , \qquad Equation 9$$

wherein
   wᵢ are the lattice points.
   n is a noise scalar; and
   c is a positive integer;

In Equation 9, fix[x] may round x to the nearest integer toward zero. The calculated scalar value S may be converted to a bit stream (520). For example, given a lattice point w={4, 2} in a D₂ lattice with c=4, S=fix{(0/2)+4×[(2+4) mod 8]}=24. Converting S=24 to binary format results in 11000. The binary stream 11000 may either be stored by RD 120 or transmitted by RD 120 to one or more BSs 110.

In some embodiments, to convert a bit stream to its corresponding lattice point w, the following algorithm may be used:

```
R = S;
k = n;
x = zeros(1, n);
for j = 1: (n−1);
  xₖ = floor(R / [0.5 * (2c)^{k-1}]);
  R = remainder(R / [0.5 * (2c)^{k-1}]);
  k = k − 1;
end
if (sum(x) is even)
  x₁ = (2 * R);
else
  x₁ = (2 * R) + 1;
end
```

From this algorithm, lattice point w may be written as wᵢ=xᵢ−c, where i=1, 2, . . . , n. For example, give a D₃ lattice with c=2, and a received bit stream of 11010, the decimal value of the received bit stream 11010 is S=26. From the for loop, it can be determined that {x2, x3}={1, 3} and R=0. Since the sum of x is even (i.e., x₂+x₃=1+3=4), x₁ may be calculated according to x₁=(2*R)=0. Finally, lattice point w may be calculated according to wᵢ=xᵢ−c, such that w₁=0−2=−2, w₂=1−2=−1, and w₃=3−2=1. Thus, in this example, lattice point w is {−2, −1, 1}.

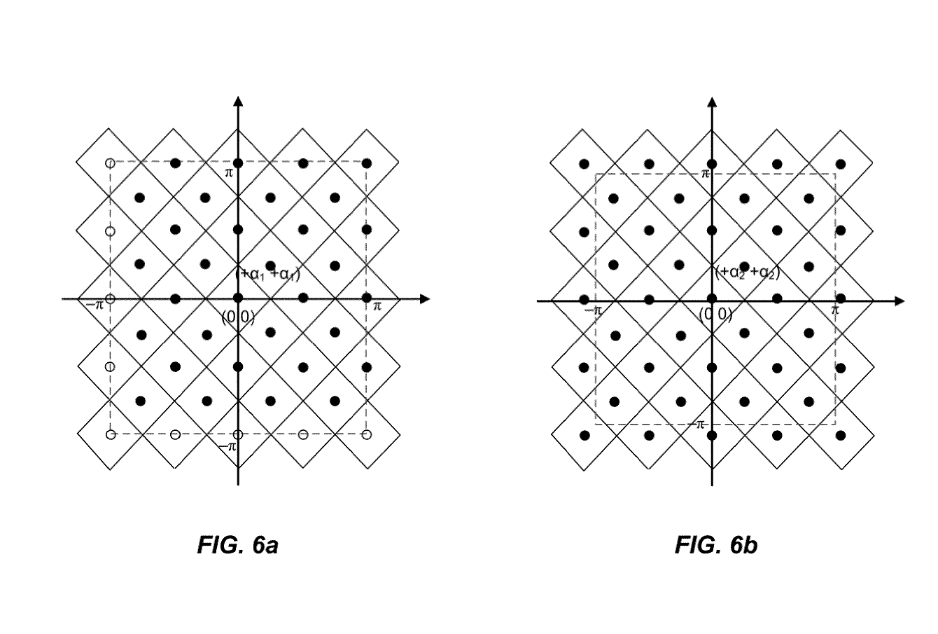

FIGS. 6a and 6b each illustrate two-dimensional phase quantization using lattice D₂. In lattice D₂, the unfilled and solid circles represent lattice points, the solid-lined squares represent the Voronoi regions corresponding to the lattice points, and the large dash-square represents the quantization region. FIG. 6a illustrates an embodiment with application of predetermined scaling factor α, whereas FIG. 6b illustrates an embodiment without predetermined scaling factor α.

Referring first to FIG. 6a, the quantization region covers 41 lattice points, each lattice point corresponding to a codeword, where the lattice points on the edges, e.g., those outside the dash-square, have at least one element being either +π or −π (e.g., (0 −π), (0 π), (−π 0), and (π 0)). Assuming a scaling factor α=α₁=π/4, and using the property that π=−π, the lattice points on the edges may be found to lead to the same codewords. Thus, lattice points having a duplicative codeword may be eliminated without affecting performance of the disclosed embodiments.

For example, in FIG. 6a, lattice point wᵢ^{t}=(−4α 2α) corresponds to equal gain precoding codeword p^{t}=(e^{-jπ} e^{jπ/2}). Similarly, lattice point wᵢ^{t}=(4α 2α) corresponds to equal gain precoding codeword p^{t}=(e^{jπ} e^{jπ/2}), which is the same as the equal gain precoding codeword corresponding to lattice point wᵢ^{t}=(−4α 2α). Because the lattice points of FIG. 6a wrap around, lattice point wᵢ^{t}=(−4α 2α) can be merged with lattice point wᵢ^{t}=(4α 2α). Thus, the 9 lattice points marked by the unfilled circles may be eliminated, so that the required number of codewords in FIG. 6a is M=32, which corresponds to the number of total quantization bits B=log₂ M=5. Finally, because the Voronoi regions of the resulting 32 codewords are all regular, the fast algorithm of Equation 7 may be applied to find the most suitable codeword given a phase vector in the quantization region.

As an example of the method of FIG. 4 using lattice D₂ of FIG. 6a, assume a 2×1 phase vector

$$Θ = π ( \begin{matrix}\frac{7}{8} & \frac{3}{8}\end{matrix} ) ,$$

that is to be quantized using lattice D₂. In this example, the predetermined scaling factor α is equal to π/4, which corresponds to c=4. First, as discussed above in connection with 410 of FIG. 4, Θ may be scaled by α (i.e., w=Θ/α), resulting in

$$w = ( \begin{matrix}\frac{7}{2} & \frac{3}{2}\end{matrix} ) .$$

Next, as discussed above in connection with 420 of FIG. 4, the algorithm of Equation 7 may be applied, i.e.,

$$\hat{w} = arg {min}_{{w}_{i}} {‖ {w}_{i} - w ‖}^{2} ,$$

resulting in ŵ=(4 2). Finally, as discussed above in connection with 430 of FIG. 4, de-scaling may be performed such that \hat{Θ}=αŵ, i.e., (π/4)(4 2). Thus, the quantized phase vector using lattice D₂ when there is application of predetermined scaling factor α may be

$$\hat{Θ} = π ( \begin{matrix}1 & \frac{1}{2}\end{matrix} ) .$$

Referring next to FIG. 6b, because FIG. 6b illustrates an embodiment that is not properly scaled, scaling factor α=α₂, where π/4<α₂<2π/7. Similarly to FIG. 6a, the quantization region of FIG. 6b also has 41 lattice points corresponding to 41 Voronoi regions. However, in contrast to FIG. 6a, none of the 41 lattice points of FIG. 6b leads to the same codeword. As a result, the wraparound property cannot be applied to this case. As a result, the number of codewords without the wraparound property is N=41. Therefore, improper scaling may result in increased quantization bits. In FIG. 6b, the codeword reduction ratio r may be defined as

$$r = \frac{N - M}{M} ,$$

which may reflect the efficiency of scaling factor α. In FIG. 6b, the codeword reduction ratio r=9/32.

While the Voronoi regions corresponding to the 16 outermost lattice points of FIG. 6b may be relatively small, removal of the 16 outermost lattice points may lead to irregular Voronoi regions for the second outermost lattice points. As a result, extra computational complexity may be required to deal with the phase vectors associated with the second outermost lattice points and, consequently, Equation 2 may not be applied to these phase vectors. To avoid the inefficient quantization bits and/or extra computational efforts associated with improper scaling, it may be beneficial to determine a scaling factor α so that lattice points on the edges may be eliminated and Equation 2 can be applied to all remaining lattice points.

FIGS. 7, 8, and 9 illustrate exemplary scaling factors α for various phase quantizers, i.e., Dₙ, Dₙ* and E₈ respectively. In the embodiments illustrated by FIGS. 7, 8, and 9, exemplary scaling factors α may lead to efficient numbers M of codewords since the lattice points on the edges result in the same codewords. In addition, the embodiments of FIGS. 7, 8, and 9 each illustrate the derivation of the corresponding number M of codewords, which are directly related to the quantization bits, for exemplary scaling factors α. That is, FIGS. 7, 8, and 9 illustrate that integer quantization bits B may be achievable using proposed scaling factors α. Moreover, using exemplary scaling factors α, the fast algorithm of Equation 7 may be used to quantize the phase vectors. As a result, there may little or no additional computational effort to deal with the lattice points on the edges since the resulting Voronoi regions are regular.

FIG. 7 is a matrix 700 illustrating a method for determining a scaling factor α, consistent with certain disclosed embodiments. That is, FIG. 7 illustrates an embodiment in which a scaling factor α is determined such that the fast algorithm of Equation 7 can be applied to all lattice codewords, thereby allowing the resulting number M of codewords to be used more efficiently during phase quanitization. As shown in FIG. 7, matrix 700 is a generation matrix of Dₙ with scaling, where lattice Dₙ is defined as Dₙ={(w₁ w₂ . . . wₙ)εZₙ:w₁+ . . . +wₙ is even}. In the embodiment of FIG. 7, the determinant of T for Dₙ is 2αⁿ.

In phase quantization, scaling factor α for Dₙ may be set to α=π/c, where c is a positive integer. With scaling factor α set to α=π/c, a set of the codewords on the edges may now lead to the same codewords and the fast algorithm of Equation 7 can be applied to all lattice codewords, thereby allowing the resulting number M of codewords to be used more efficiently during phase quanitization. That is, Dₙ can be obtained by alternatively selecting the points of Zₙ, and taking the selected points. Hence, Dₙ may have a number M=(2c)ⁿ/2 of resulting codewords in the quantization region. By substituting c=π/α, the resulting number M of codewords may be given by Equation 10, as follows:

$$M = {( \frac{π}{α} )}^{n} {2}^{n + 1} . \qquad Equation 10$$

Using Equation 10, when c=2^{k}, where k is an integer and k≧0, the quantization bit B=log₂ M is an integer. In this embodiment, lattice D₂ may be congruent to the two-dimensional scalar quantization, i.e., the lattice Z₂. Using a proper scaling factor α for both lattices D₂ and Z₂, a different bit resolution may be achieved for these two lattices. For example, in lattice Z₂, the quantization bits may be multiples of n, i.e., B is even, whereas for lattice D₂, the quantization bits B are odd when c=π/α is even. As a result, using the lattices D₂ and Z₂ together can achieve a wider range of bit resolution.

FIG. 8 is a matrix 800 illustrating a method for determining a scaling factor α, consistent with certain disclosed embodiments. That is, FIG. 8 illustrates an embodiment in which a scaling factor α is determined such that the fast algorithm of Equation 7 can be applied to all lattice codewords, thereby allowing the resulting number M of codewords to be used more efficiently during phase quanitization. As shown in FIG. 8, matrix 800 is a generation matrix of lattice Dn* with scaling, where dual lattice Dn is defined as the union of the points of the n-dimensional integer lattice Zₙ, and the translation of lattice Zₙ by the vector

$$( 1 / 2 \; 1 / 2 … 1 / 2 ) , i . e . , {D}_{n}^{*} = {Z}_{n} ⋃ ( \frac{1}{2} + {Z}_{n} ) .$$

In FIG. 8, the determinant T of matrix 800 is 0.5αⁿ, and the scaling factor α for Dₙ* is α=π/c, where c is either a positive integer or a positive integer plus ½. With scaling factor α=π/c, the codewords on the edges may lead to the same codewords, and the corresponding number M of codewords in the quantization region may be given by Equation 10 above.

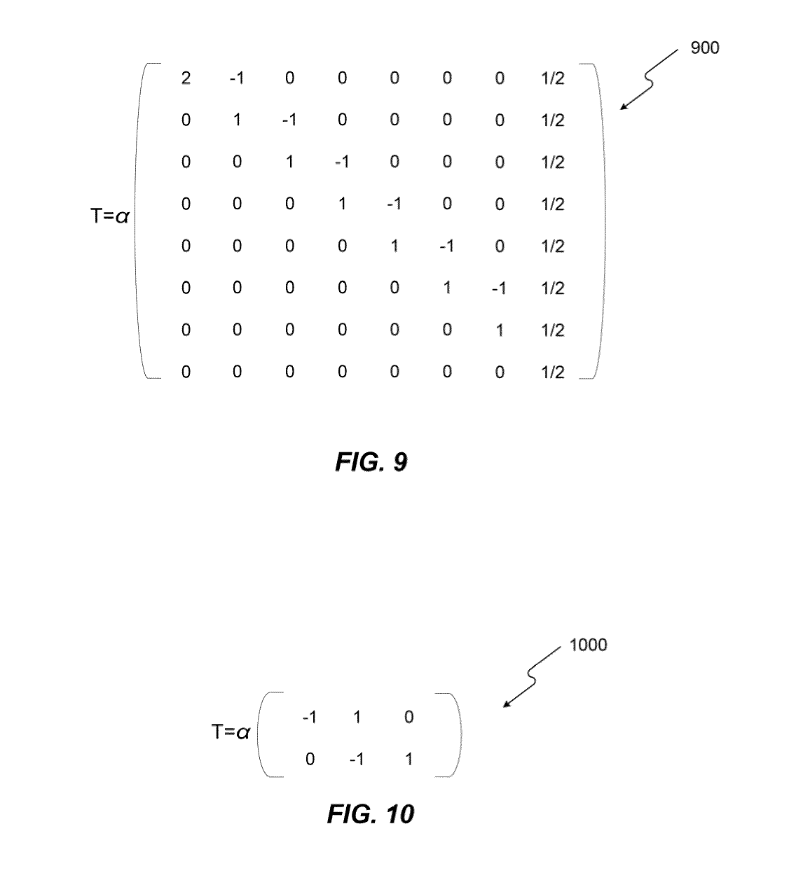

FIG. 9 is a matrix 900 illustrating a method for determining a scaling factor α, consistent with certain disclosed embodiments. That is, FIG. 9 illustrates an embodiment in which a scaling factor α is determined such that the fast algorithm of Equation 7 can be applied to all lattice codewords, thereby allowing the resulting number M of codewords to be used more efficiently during phase quanitization. As shown in FIG. 9, matrix 900 is a generation matrix of lattice E₈ with scaling, where the lattice E₈ in the even coordinate system is defined as E₈={(w₁ w₂ . . . w₈)εZ₈ or Z₈+1:w₁+ . . . +w₈ is even}.

In FIG. 9, the determinant T of matrix 900 is 1, and the proper scaling factor α for lattice E₈ is α=π/c, where c is either a positive integer or a positive integer plus ½. With scaling factor α=π/c, the codewords on the edges may lead to the same codewords, and the corresponding number M of codewords in the quantization region may be given by Equation 10 above, i.e.,

$$M = 256 {( \frac{π}{α} )}^{8} .$$

When c=2^{k}, where k is an integer and k≧0, the quantization bit B of the embodiment of FIG. 9 may be an integer. Notably, however, although c can also be an integer plus ½ for lattice E₈, the lattice points that can be eliminated using the wraparound property may be more efficient when c is an integer than when c is an integer plus ½. That is, when c is an integer plus ½, and an element of a lattice E₈ lattice point is wᵢ=+c, the vector formed by letting wᵢ=−c, other elements unchanged, may no longer be a lattice point of lattice E₈. For example, when c= 3/2 and a scaled lattice point of lattice E₈ is

$$( \frac{3}{2} \frac{1}{2} \frac{1}{2} \frac{1}{2} \frac{1}{2} \frac{1}{2} \frac{1}{2} \frac{- 1}{2} ) ,$$

multiplying the first element by a minus sign, i.e.,

$$( \frac{- 3}{2} \frac{1}{2} \frac{1}{2} \frac{1}{2} \frac{1}{2} \frac{1}{2} \frac{1}{2} \frac{- 1}{2} ) ,$$

causes the lattice point to no longer be a lattice point of lattice E₈. As a result, the number of lattice points that can be eliminated when cεZ+½ may be fewer than when cεZ.

In some embodiments, it may be desirable to perform dimension transformation, i.e., transforming from a lower dimension matrix to a higher dimension matrix and/or transforming from a higher dimension matrix to a lower dimension matrix, such that a scaling factor α may be determined using the fast algorithm of Equation 7. Using dimension transformation and the fast algorithm of Equation 7, the resulting number M of codewords may be used more efficiently during phase quantization.

Generally, to perform dimension transformation on a lattice, the lattice points are obtained. In the embodiment of FIG. 10, the lattice points may be obtained by spanning the column space of matrix T, where matrix T is a generation matrix of the lattice having a size m×n, where m>n. Because matrix T is of rank n, Singular Value Decomposition (SVD) may be applied to matrix T, according to Equation 11, as follows:

$$T = ( {U}_{0} {U}_{1} ) ( \frac{\sum }{{0}_{( m - n ) \times n}} ) {v}^{t} = {U}_{0} \sum {V}^{t} , \qquad Equation 11$$

wherein
   U₀ is matrix of size m×n; and
   Σ is an n×n diagonal matrix consisting of n singular values of matrix T.

Applying Equation 6, as disclosed above, when a resulting higher-dimensional codeword wᵢ is multiplied by U₀^{t}, the lower-dimensional codeword νᵢ may be given by νᵢ=U₀^{t}wᵢ. Thus, a lower-dimensional codeword may be transformed to its higher-dimensional codeword by applying Equation 12, as follows:

wᵢ=U₀νᵢ. Equation 12

FIG. 10 is a matrix 1000 illustrating a method for dimension transformation, consistent with certain disclosed embodiments. That is, FIG. 10 illustrates an embodiment in which dimension transformation is performed, i.e., transforming from a lower dimension matrix to a higher dimension matrix and/or transforming from a higher dimension matrix to a lower dimension matrix, such that a scaling factor α may be determined using the fast algorithm of Equation 7, thereby allowing the resulting number M of codewords to be used more efficiently during phase quantization. As shown in FIG. 10, matrix 1000 is a generation matrix of a lattice A₂ with scaling, where lattice A₂ is defined as A₂={(w₀, w₁, w₂)εZ₃:w₀+w₁+w₂=0}.

In the embodiment illustrated by FIG. 10, while lattice A₂ has three elements, these elements may only provide useful information for two dimensions, i.e., n=2. Thus, to achieve better results, it may be desirable to transform the phase vector of lattice A₂ to a higher dimension matrix. After the most suitable codeword is found, the resulting codeword may be transformed back to a lower dimension matrix.

For example, lattice A₂ may be transformed by ignoring scaling factor α and performing SVD on lattice A₂. The result may be shown by matrix U₀, i.e.,

$${U}_{0} = {( \frac{\begin{matrix}\frac{- 1}{\sqrt{6}} & \frac{2}{\sqrt{6}} & \frac{- 1}{\sqrt{6}}\end{matrix}}{\begin{matrix}\frac{- 1}{\sqrt{2}} & 0 & \frac{1}{\sqrt{2}}\end{matrix}} )}^{t} .$$

Next, a transformation matrix Q corresponding to lattice A₂ may be normalized so that the shortest distance between neighboring two-dimensional lattice points is 1 when scaling factor α=1. Thus, for example, when u₀=(0 0 0)^{t} and u₁=(0 0 1)^{t}, the distance between QTu₀ and QTu₁ is 1 when α=1. This may be achieved by dividing U₀^{t} by \sqrt{2}, i.e.,

$$Q = \frac{1}{\sqrt{2}} {U}_{0}^{t} = ( \frac{\begin{matrix}\frac{- 1}{\sqrt{12}} & \frac{2}{12} & \frac{- 1}{\sqrt{12}}\end{matrix}}{\begin{matrix}\frac{- 1}{2} & 0 & \frac{1}{2}\end{matrix}} ) .$$

When the elements of uᵢ are combinations of 0 and ±1, QTuᵢ will produce 7 lattice points, resulting in a hexagonal lattice. To transform the codeword from a lower-dimensional codeword to a higher-dimensional codeword, the lower-dimensional codeword may be multiplied by the pseudo inverse of matrix Q, i.e.,

$${Q}^{inv} = \sqrt{2} {U}_{0} = ( \frac{\begin{matrix}\frac{- 1}{\sqrt{3}} & \frac{2}{\sqrt{3}} & \frac{- 1}{\sqrt{3}}\end{matrix}}{\begin{matrix}- 1 & 0 & 1\end{matrix}} ) .$$

For the lattice A₂, there are two elements in each lower dimensional lattice point. Since a hexagonal lattice is not symmetric about the all-zero lattice point, the lattice points of A₂ on the edges will only have one element that is ±π, with or without scaling factor α, resulting in an inefficient codeword number. Therefore, for A₂, in addition to finding a suitable value of scaling factor α, phase quantization may also be performed to cause more lattice points on the edges to have an efficient codeword number.

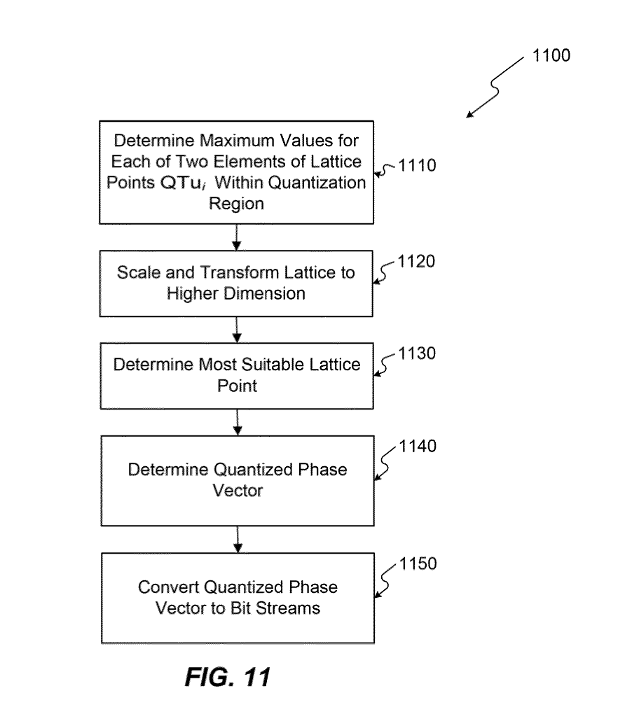

FIG. 11 is an exemplary flowchart 1100 illustrating phase quantization in a wireless communication system, such as wireless communication system 100, consistent with certain disclosed embodiments. Specifically, FIG. 11 illustrates an embodiment in which equal gain precoder 300 performs lattice scaling and phase quantization on a lattice, such as lattice A₂. In the disclosed embodiments, scaling may be used to achieve different quantization bits. For a phase quantizer, the phase to be quantized is in the range of [−π, π].

As shown in FIG. 11, for a specific scaling factor α, a maximum value for each of the two neighboring lattice points QTuᵢ within the quantization region may be determined (1110). The maximum value of the i^{th} element may be denoted as θ_{i,max}, where |θ_{i,max}|≦π. Referring to matrix T of FIG. 10, when α=π, the maximum value of lattice point QTu₁ is θ_{1,max}=0.8667π, and the maximum value of lattice points QTu₂ is θ_{2,max}=π. In some embodiments, the maximum values may be obtained from the 7 codewords in the quantization region.

Next, phase vector Θ may be scaled and transformed to a higher dimension (1120). In some embodiments, scaling and transformation of lattice A₂ may be performed according to Equation 13, as follows:

w=Q^{inv}Θ/α. Equation 13

The most suitable lattice point ŵ may be obtained using lattice point w (1130). In some embodiments, the fast algorithm of Equation 7 above may be used to obtain the most suitable lattice point ŵ, i.e.,

$$\hat{w} = arg {min}_{{w}_{i}} {‖ {w}_{i} - w ‖}^{2} ,$$

from which the quantized phase vector may be obtained (1140). In some embodiments, the quantized phase vector may be obtained by de-scaling and transformation, i.e., \hat{Θ}=αQŵ. If any of the resulting elements \hat{Θ}ᵢ achieves the corresponding maximum value \hat{Θ}_{i,max}, that element may be replaced π. Using this ceiling-like process, there may be more lattice points on the edges, resulting in a more efficient number of codewords.

Next, the quantized phase vectors may be converted to bit streams (1150). In some embodiments, the quantized phase vectors may be converted to bit streams as discussed above in connection with FIG. 5. The bit streams may be stored by RD 120 and/or transmitted to BS 110 by RS 120 via one or more feedback messages.

While the embodiments disclosed herein refer to the 3GPP standards and technologies, the disclosed embodiments may also be used in wireless communications systems utilizing the Institute of Electrical and Electronics Engineers (IEEE) 802.16 family of standards and technologies. For example, the disclosed embodiments may also be used in a wireless communication system using Worldwide Interoperability for Microwave Access (WiMAX), which is promulgated by the WiMax Forum, and is based on the IEEE 802.16 family of standards and technologies.

The apparatuses and methods disclosed herein may be configured to prevent signals from different transmission nodes from being destructive to each other, thereby causing macro-diversity gain to be lost. In addition, the apparatuses and methods disclosed herein may reduce computational costs associated with more exhaustive search methods, and reduce the amount of feedback overhead. In this manner, the disclosed embodiments may reduce signal processing time and improve data traffic flow associated with signal transmission in any type of wireless network. Similarly, the methods and apparatus as described in connection with the disclosed embodiments may be configured to operate in any transmitting and/or receiving device.

It will be apparent to those skilled in the art that various modifications and variations can be made in the system and method for reception in communication networks. It is intended that the standard and examples be considered as exemplary only, with a true scope of the disclosed embodiments being indicated by the following claims and their equivalents.

What is claimed is:

1. A method for phase quantization and equal gain precoding in a wireless communication system, comprising:
scaling, by a receiving device, a phase vector based on a predetermined scaling factor to determine a first lattice point;
determining, by the receiving device, a second lattice point based on the determined first lattice point; and
determining, by the receiving device, a quantized phase vector based on the determined second lattice point and the predetermined scaling factor.

2. The method as in claim 1, further including:
converting, by the receiving device, the quantized phase vector to a bitstream; and
transmitting, by the receiving device, the bitstream to a transmitting device.

3. The method as in claim 2, wherein converting the quantized phased vector further includes:
calculating, by the receiving device, a scalar value for the first lattice point; and
converting, by the receiving device, the quantized phase vector to the bitstream based on the calculated scalar value.

4. The method as in claim 1, further including:
determining, by the receiving device, a first neighboring lattice point and a second neighboring lattice point; and
determining, by the receiving device, a first maximum value associated with the first neighboring lattice point and a second maximum value associated with the second neighboring lattice point.

5. The method as in claim 4, wherein determining the quantized phase vector further includes:
descaling the phase vector to generate a descaled phase vector; and
replacing, when an element of the descaled phase vector is greater than the determined first maximum value or the second maximum value, the element of the descaled phase vector with π.

6. An apparatus for phase quantization and equal gain precoding in a wireless communication system, the apparatus comprising:
at least one memory to store data and instructions; and
at least one processor configured to access the at least one memory and, when executing the instructions, to:
scale a phase vector based on a predetermined scaling factor to determine a first lattice point;
determine a second lattice point based on the determined first lattice point; and
determine a quantized phase vector based on the determined second lattice point and the predetermined scaling factor.

7. The apparatus as in claim 6, wherein the at least one processor is further configured to:
convert the quantized phase vector to a bitstream; and
transmit the bitstream to a transmitting device.

8. The apparatus as in claim 7, wherein when the at least one processor is configured to convert the quantized phase vector to the bitstream, the at least one processor is further configured to:
calculate a scalar value for the first lattice point; and
convert the quantized phase vector to the bitstream based on the calculated scalar value.

9. The apparatus as in claim 6, wherein the at least one processor is further configured to:
determine a first neighboring lattice point and a second neighboring lattice point; and
determine a first maximum value associated with the first neighboring lattice point and a second maximum value associated with the second neighboring lattice point.

10. The apparatus as in claim 9, wherein when the at least one processor is configured to determine the quantized phase vector, the at least one processor is further configured to:
descale the phase vector to generate a descaled phase vector; and
replace, when an element of the descaled phase vector is greater than the determined first maximum value or the second maximum value, the element of the descaled phase vector with π.

11. A method for phase quantization and equal gain precoding in a wireless communication system, comprising:
scaling, by a receiving device, a phase vector based on a predetermined scaling factor to determine a first lattice point;
determining, by the receiving device, a second lattice point based on the determined first lattice point;
determining, by the receiving device, a quantized phase vector based on the determined second lattice point and the predetermined scaling factor;
calculating, by the receiving device, a scalar value for the first lattice point;
converting, by the receiving device, the quantized phase vector to a bitstream based on the calculated scalar value; and
transmitting, by the receiving device, the bitstream to a transmitting device.

12. The method as in claim 11, further including:
determining, by the receiving device, a first neighboring lattice point and a second neighboring lattice point; and
determining, by the receiving device, a first maximum value associated with the first neighboring lattice point and a second maximum value associated with the second neighboring lattice point.

13. The method as in claim 12, wherein determining the quantized phase vector further includes:
descaling the phase vector to generate a descaled phase vector; and
replacing, when an element of the descaled phase vector is greater than the determined first maximum value or the second maximum value, the element of the descaled phase vector with π.

14. An apparatus for phase quantization and equal gain precoding in a wireless communication system, the apparatus comprising:
at least one memory to store data and instructions; and
at least one processor configured to access the at least one memory and, when executing the instructions, to:
scale a phase vector based on a predetermined scaling factor to determine a first lattice point;
determine a second lattice point based on the determined first lattice point;
determine a quantized phase vector based on the determined second lattice point and the predetermined scaling factor;
calculate a scalar value for the first lattice point;
convert the quantized phase vector to a bitstream based on the calculated scalar value; and
transmit the bitstream to a transmitting device.

15. The apparatus as in claim 14, wherein when the at least one processor is configured to determine the quantized phase vector, the at least one processor is further configured to:
descale the phase vector to generate a descaled phase vector; and
replace, when an element of the descaled phase vector is greater than the determined first maximum value or the second maximum value, the element of the descaled phase vector with π.
